(19) United States
(12) Patent Application Publication
(10) Pub. No.: US 2007/0150270 A1
(43) Pub. Date: Jun. 28, 2007

(54) Method for removing background noise in a speech signal

(76) Inventor: Tai-Huei Huang, Siluo Township (TW)

Correspondence Address: J.C. Patents, Inc., Suite 250, 4 Venture, Irvine, CA, 92618, US

(21) Appl. No.: 11/372,315

(22) Filed: Mar. 8, 2006

(30) Foreign Application Priority Data
Dec. 26, 2005 (TW) 94146476

(51) Int. Cl. G10L 21/02

(52) U.S. Cl. 704/226

(57) ABSTRACT

A method for removing a background noise from a speech signal is provided, which comprises the following steps. First, an attenuation factor of a frequency band i is calculated. Then, a smoothing filtering is performed based on the attenuation factors of the frequency bands to calculate a forward attenuation factor and a backward attenuation factor of the frequency band i. Then, a linear combination is performed on the forward attenuation factor and the backward attenuation factor to calculate a smooth attenuation factor of the frequency band i. Afterwards, a speech spectrum estimation is calculated based on the smooth attenuation factor. Finally, a speech signal without the background noise is obtained by using an inverse Fourier transform.

### CROSS-REFERENCE TO RELATED APPLICATION

This application claims the priority benefit of Taiwan application serial no. 94146476, filed on Dec. 26, 2005. All disclosure of the-Taiwan application is incorporated herein by reference.

### BACKGROUND OF THE INVENTION

1. Field of the Invention

The present invention relates to a method for removing a background noise in a speech signal, and more particularly, to a method for performing a smoothing filtering on the attenuation factor of each frequency band in a speech signal.

2. Description of the Related Art

According to the result of the customer satisfaction survey for the hearing aid, the user of the hearing aid usually has complaints as quoted “the environmental noise is amplified too much which easily makes me feel tired” and “I can hear but cannot hear it clearly”. Therefore, a method for removing the noise in the signal to improve the comfort in wearing the hearing aid had become one of the most important subjects in developing the digital hearing aid technology. Currently, some methods for removing the background noise in a speech signal significantly improve the signal to noise ratio (SNR). However, such methods do not improve the speech recognizing ability, and in some cases, such methods even generate additional noise (also known as “musical noise”) or impact the smoothness of the speech.

The background noise interference is combination of time domain waveforms. Here, the noisy speech signal is represented as γ[n]=x[n]+w[n], wherein x[n] represents a non-interfered speech signal, and w[n] represents a background noise.

A conventional method for removing the noise is represented as \hat{X}[i]=γ[i]Y[i], wherein Y[i] is a spectral component at frequency band i which is obtained after performing a fast Fourier transform on the noisy speech signal γ[n], i ∈[0, N−1], N is the number of the frequency bands, |Y[i]| represents a amplitude of the noisy speech signal γ[n] in the frequency band i, and γ[i] represents an attenuation factor of the amplitude.

A conventional method for calculating the attenuation factor is

$$γ [ i ] = \frac{{\vert D [ i ] \vert}^{2}}{{\vert Y [ i ] \vert}^{2}} ,$$

wherein

$${\vert D [ i ] \vert}^{2} = \{ \begin{matrix}{\vert Y [ i ] \vert}^{2} - α {\vert W [ i ] \vert}^{2} , if {\vert Y [ i ] \vert}^{2} \geq \frac{α}{1 - β} {\vert W [ i ] \vert}^{2} \\ β {\vert Y [ i ] \vert}^{2} , elsewhere\end{matrix} , {\vert W [ i ] \vert}^{2}$$

is an energy of the background noise in the frequency band i, and α and β are the predetermined coefficients. Therefore, once \hat{X}[i]=γ[i]Y[i] is calculated, an inverse Fourier transform is performed on \hat{X}[i] to obtain a speech signal without the background noise.

The speech signal has correlation between the neighboring frequency bands. However, as described above, the conventional method does not make good use of it. In the conventional technique, the amplitude attenuation factors are calculated separately for each frequency band, thus there is room for improvement in the conventional technique.

### SUMMARY OF THE INVENTION

Therefore, it is an object of the present invention to provide a method for removing a background noise in a speech signal. The method improves the sound quality and intelligibility of the speech signal in which the background noise is removed.

In order to achieve the object mentioned above and others, the present invention provides a method for removing a background noise in a speech signal, which comprises the following steps. First, an attenuation factor

$$γ [ i ] = \frac{{\vert D [ i ] \vert}^{2}}{{\vert Y [ i ] \vert}^{2}}$$

of a frequency band i is defined. Wherein,

$${\vert D [ i ] \vert}^{2} = \{ \begin{matrix}{\vert Y [ i ] \vert}^{2} - α {\vert W [ i ] \vert}^{2} , if {\vert Y [ i ] \vert}^{2} \geq \frac{α}{1 - β} {\vert W [ i ] \vert}^{2} \\ β {\vert Y [ i ] \vert}^{2} , elsewhere\end{matrix} , {\vert Y [ i ] \vert}^{2}$$

is a energy of the noise speech signal in the frequency band i, |W[i]|² is an energy of the background noise in the frequency band i, i ∈[0, N−1] , N is the number of the frequency bands, and α and β are the predetermined coefficients. Then, a forward filtering on the attenuation factor of the frequency band i is performed by γ̅_{f}[i]≡ γ̅[i]=λ_{f}·γ[i]+(1−λ_{f}) γ̅[i−1], wherein λ_{f} is a predetermined coefficient. Then, a backward filtering on the attenuation factor of the frequency band i is performed by γ̅_{b}[i]=λ_{b}·γ_{b}[i]+(1−λ_{b}) γ̅_{b}[i−1], wherein γ_{b}[i]=γ[N−1−i], and λ_{b} is a predetermined coefficient. Afterwards, a speech spectrum estimation \hat{X}[i]=\hat{γ}[i]Y[i] is calculated based on the attenuation factor \hat{γ}[i]=λ_{c}· γ̅_{f}[i]+(1−λ_{c}) γ̅_{b}[N−1−i]). Finally, a speech signal in which the background noise is removed is obtained by performing an inverse Fourier transform on \hat{X}[i].

In an embodiment of the method for removing the background noise in a speech signal, γ̅[−1]=γ[0], and γ̅_{b}[−1]=γ[N−1].

In accordance with a preferred embodiment of the present invention, the method for removing the background noise in a speech signal mentioned above uses a correlation between the neighboring frequency bands in a speech signal to perform a smoothing filtering, so as to replace the conventional amplitude attenuation factor. As shown in the experimental results, such method can improve the sound quality and intelligibility of the speech signal in which the background noise is removed.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 schematically shows a block diagram illustrating a method for removing a background noise in a speech signal according to an embodiment of the present invention.

FIG. 2 is a diagram showing variances of the attenuation factors in the conventional technique and an embodiment of the present invention.

### DESCRIPTION PREFERRED EMBODIMENTS

The speech spectrum without the background noise obtained in the conventional technique is calculated for each frequency band. However, the method provided by the present invention uses a correlation between the neighboring frequency bands to improve the intelligibility of the speech signal in which the background noise is removed.

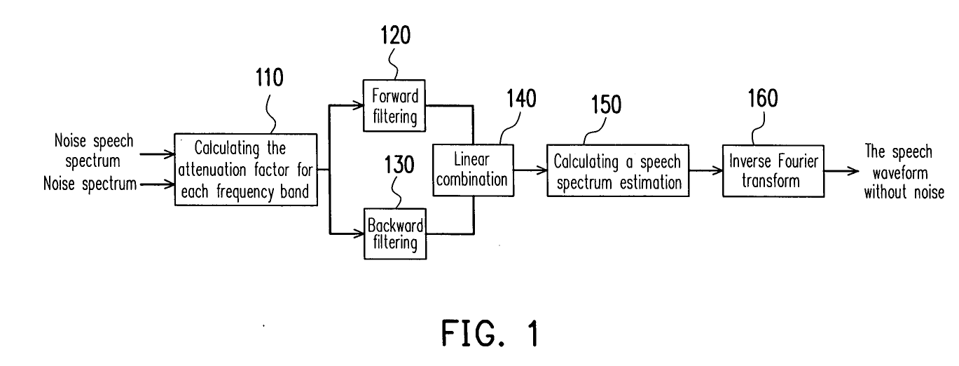

FIG. 1 schematically shows a block diagram illustrating a method for removing a background noise in a speech signal according to an embodiment of the present invention. Referring to FIG. 1, first in step 110, the attenuation factor for each frequency band is calculated. It is assumed in the present embodiment that the number of the frequency bands is N, i ∈[0, N−1] , and the attenuation factor of the frequency band i is

$$γ [ i ] = \frac{{\vert D [ i ] \vert}^{2}}{{\vert Y [ i ] \vert}^{2}} .$$

Wherein,

$${\vert D [ i ] \vert}^{2} = \{ \begin{matrix}{\vert Y [ i ] \vert}^{2} - α {\vert W [ i ] \vert}^{2} , if {\vert Y [ i ] \vert}^{2} \geq \frac{α}{1 - β} {\vert W [ i ] \vert}^{2} \\ β {\vert Y [ i ] \vert}^{2} , elsewhere\end{matrix} , {\vert Y [ i ] \vert}^{2}$$

is an energy of the first received noisy speech signal in the frequency band i, |W[i]|² is an energy of the background noise in the frequency band i, and α and β are the predetermined coefficients.

After the attenuation factor is calculated, in step 120, a first order IIR (infinite impulse response) filter q[n]=λp[n]+(1−λ)q[n−1] performs a filtering on the attenuation factor γ[i] of the frequency band i to calculate a forward attenuation factor γ̅_{f}[i] of the frequency band i. In the present embodiment, the equation is γ̅_{f}[i]≡ γ̅[i]=λ_{f}·γ[i]+(1−λ_{f}) γ̅[i−1], wherein λ_{f} is a predetermined coefficient. It is known from a simple inference that the forward attenuation factor γ̅_{f}[i] is calculated based on γ[0] to γ[i].

Then, in step 130, the first order IIR filter performs a filtering on the attenuation factor γ[i] in which the frequency band order is reverse to calculate a backward attenuation factor γ̅_{b}[i] of the frequency band i. In the present embodiment, the equation is γ̅_{b}[i]=λ_{b}·γ_{b}[i]+(1−λ_{b}) γ̅_{b}[i−1] , wherein γ_{b}[i]=γ[N−1−i], and λ_{b} is a predetermined coefficient. It is known from a simple inference that the backward attenuation factor γ̅_{b}[i] is calculated based on γ[N−1] to γ[N−1−i].

In the differential equation computation mentioned above, the initial condition is γ̅[−1]=γ[0], and γ̅_{b}[−1]=γ[N−1].

Then, in step 140, a linear combination is performed on the forward and backward filtering results to calculate a smooth attenuation factor \hat{γ}[i] of the frequency band i. In the present invention, the equation is \hat{γ}[i]=λ_{c}· γ̅_{f}[i]+(1−λ_{c}) γ̅_{b}[N−1−i]), wherein λ_{c} is a predetermined coefficient. Then, in step 150, a speech spectrum estimation after the smoothing filtering \hat{X}[i]=\hat{γ}[i]Y[i] is calculated. Finally, in step 160, an inverse Fourier transform is performed on \hat{X}[i] to obtain a speech signal without the background noise.

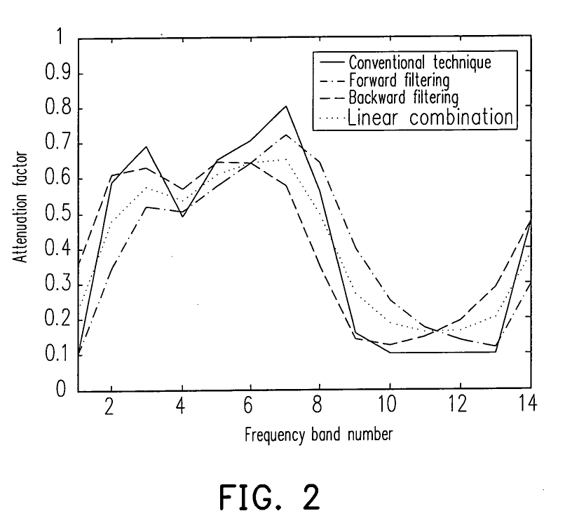

FIG. 2 is a diagram showing the attenuation factor variances in the conventional technique and according to an embodiment of the present invention, wherein X-axis is the frequency band number, and Y-axis is the attenuation factor value. In FIG. 2, λ_{f}=λ_{b}=λ_{c}=0.5, the solid line marked for the conventional technique, and all other dot lines represent the data of the present embodiment. As shown in FIG. 2, as a result of combining the forward and backward results, the value of the attenuation factor for each frequency band is adjusted in response to the impact from the attenuation factors of its left and right frequency bands, such that the purpose of adjusting the attenuation factor of the frequency band by using the correlation between the frequency bands is achieved.

The experimental result of the present embodiment is described hereinafter. The first experiment is related to a test of the syllable intelligibility. In this experiment, a clean speech database for training the Chinese syllable models was collected from 18 males and 11 females, in which each speaker utters 120 Chinese names in a quiet room. The noisy speech database is generated by adding various noises including the operation room noise, the white noise, the babble noise, and the factory noise into the clean speech database at a signal to noise ratio (SNR) of 20 dB, 15 dB, 10 dB, 5 dB, and 0 dB, respectively. After the method for removing the background noise of the present embodiment is applied on each speech file of the noise speech database to filter the noise and to apply the clean speech models to perform the automatic syllable recognition, a result as shown below is obtained. Each of the experiment data shown below is an average value of 20 combinations that include the combinations of 4 noises and 5 SNRs.

TABLE 1
Experiment data of syllable recognizing
ability test in present embodiment

| | λ value | | | | | | |
|---|---|---|---|---|---|---|---|
| | 1.0 | 0.7 | 0.6 | 0.55 | 0.5 | 0.45 | 0.4 |
| Syllable | 41.8 | 44.8 | 45.6 | 45.8 | 46.1 | 46.2 | 45.9 |
| correctness | | | | | | | |
| (%) | | | | | | | |

In the present experiment, λ_{f}=λ_{b}=λ. When λ=1, the smooth attenuation factor \hat{γ}[i] equals the conventional attenuation factor γ[i]. Thus, when λ=1, the experiment data of the conventional method is 41.8%. On the other hand, the syllable correctness without removing the noise is 32.9%. As shown in TABLE 1, the method of the present embodiment can improve the recognition accuracy of the speech signal in which the background noise is removed, when λ=0.45, the maximum recognition accuracy is up to 46.2%.

The second experiment uses PESQ (perceptual evaluation of speech quality), which is used to measure the speech quality, to compare various results obtained from different methods. The score range of PESQ is [0, 4], wherein 4 accounts for no signal distortion. The experimental result is shown in TABLE 2 below.

TABLE 2
Evaluation of speech quality without background noise

λ value

| | 1.0 | 0.5 |
|---|---|---|
| PESQ score | 2.44 | 2.45 |

Similarly, in the present experiment, λ_{f}=λ_{b}=λ, when λ=1, the PESQ score of the conventional method is 2.44. On the other hand, the score of not removing the noise is 2.08. As shown in TABLE 2, the method of the present embodiment can improve the quality of the speech signal in which the background noise is removed.

Although the present invention is inspired by the digital hearing aid, the application of the present invention should not be limited only in the digital hearing aid. The present invention also can be applied in other fields, such as the voice recording in the digital recording pen.

In summary, in the method for removing the background noise in a speech signal provided by the present invention, a smoothing filtering is performed on the attenuation factor by using the correlation between the neighboring frequency bands in the speech signal. As shown in the experimental results, the method mentioned above can improve the quality and intelligibility of the speech signal in which the background noise is removed.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A method for removing a background noise in a speech signal, comprising:
defining an attenuation factor
$$γ [ i ] = \frac{{\vert D [ i ] \vert}^{2}}{{\vert Y [ i ] \vert}^{2}}$$
of a frequency band i, wherein
$${\vert D [ i ] \vert}^{2} = \{ \begin{matrix}{\vert Y [ i ] \vert}^{2} - α {\vert W [ i ] \vert}^{2} , if {\vert Y [ i ] \vert}^{2} \geq \frac{α}{1 - β} {\vert W [ i ] \vert}^{2} \\ β {\vert Y [ i ] \vert}^{2} , elsewhere\end{matrix} , {\vert Y [ i ] \vert}^{2}$$
is an energy of a noisy speech signal in the frequency band i, |W[i]|² is an energy of the background noise in the frequency band i, i ∈[0, N−1], N is the number of the frequency bands, and α and β are predetermined coefficients;
calculating a forward attenuation factor γ̅_{f}[i] of the frequency band i based on γ[0] to γ[i];
calculating a backward attenuation factor γ̅_{f}[i] of the frequency band i based on γ[N−1]to γ[N−1−i];
calculating a smooth attenuation factor \hat{γ}[i] of the frequency band i based on γ̅_{f}[i] and γ̅_{b}[i];
calculating a speech spectrum estimation \hat{X}[i]=\hat{γ}[i]Y[i]; and
performing an inverse Fourier transform on \hat{X}[i] to obtain a speech signal without the background noise.

2. The method for removing the background noise in the speech signal of claim 1, wherein \hat{γ}_{f}[i]≡\hat{γ}[i]=λ_{f}·γ[i]+(1−λ_{f}) γ̅[i−1], and λ_{f} is a predetermined coefficient.

3. The method for removing the background noise in the speech signal of claim 2, wherein γ̅[−1]=γ[0].

4. The method for removing the background noise in the speech signal of claim 2, wherein λ_{f} is 0.5.

5. The method for removing the background noise in the speech signal of claim 1, wherein γ̅_{b}[i]=λ_{b}·γ_{b}[i]+(1−λ_{b}) γ̅_{b}[i−1], γ_{b}[i]=γ[N−1−i], and λ_{b} is a predetermined coefficient.

6. The method for removing the background noise in the speech signal of claim 5, wherein γ̅_{b}[−1]=γ[N−1].

7. The method for removing the background noise in the speech signal of claim 5, wherein λ_{b} is 0.5.

8. The method for removing the background noise in the speech signal of claim 1, wherein \hat{γ}[i]=λ_{c}· γ̅_{f}[i]+(1−λ_{c}) γ̅_{b}[N−1−i]), and λ_{c} is a predetermined coefficient.

9. The method for removing the background noise in the speech signal of claim 8, wherein λ_{c} is 0.5.

10. A method for removing a background noise in a speech signal, comprising:
defining an attenuation factor
$$γ [ i ] = \frac{{\vert D [ i ] \vert}^{2}}{{\vert Y [ i ] \vert}^{2}}$$
of a frequency band i, wherein
$${\vert D [ i ] \vert}^{2} = \{ \begin{matrix}{\vert Y [ i ] \vert}^{2} - α {\vert W [ i ] \vert}^{2} , if {\vert Y [ i ] \vert}^{2} \geq \frac{α}{1 - β} {\vert W [ i ] \vert}^{2} \\ β {\vert Y [ i ] \vert}^{2} , elsewhere\end{matrix} , {\vert Y [ i ] \vert}^{2}$$
is an energy of a noise speech signal in the frequency band i, |W[i]|² is an energy of the background noise in the frequency band i, i ∈[0, N−1], N is a quantity of the frequency bands, and α and β are predetermined coefficients;
calculating a forward attenuation factor γ̅_{f}[i]≡ γ̅[i]=λ_{f}·γ[i]+(1−λ_{f}) γ̅[i−1]of the frequency band i, wherein λ_{f} is a predetermined coefficient;
calculating a backward attenuation factor \hat{γ}_{b}[i]=λ_{b}·γ_{b}[i]+(1−λ_{b}) γ̅_{b}[i−1] of the frequency band i, wherein γ_{b}[i]=γ[N−1−i], and λ_{b} is a predetermined coefficient;
calculating a smooth attenuation factor \hat{γ}[i]=λ_{c}· γ̅_{f}[i]+(1−λ_{c}) γ̅_{b}[N−1−i]) of the frequency band i, wherein λ_{c} is a predetermined coefficient;
calculating a speech spectrum estimation \hat{X}[i]=\hat{γ}[i]Y[i]; and
performing an inverse Fourier transform on \hat{X}[i] to obtain a speech signal without the background noise.

11. The method for removing the background noise in the speech signal of claim 10, wherein γ̅[−1]=γ[0], and γ̅_{b}[−1]=γ[N−1].

12. The method for removing the background noise in the speech signal of claim 10, wherein λ_{f}=λ_{b}=λ_{c}=0.5.
